(19) United States
(12) Patent Application Publication
(10) Pub. No.: US 2026/0070069 A1
(43) Pub. Date: Mar. 12, 2026

(54) PURIFICATION OF MINERAL ORES USING CATIONIC COPOLYMERS

(71) Applicant: Ecolab USA Inc., St. Paul, MN (US)

(72) Inventors: Ryan Travis Chester, Connolly (AU); Mingli Wei, Naperville, IL (US); Rangarani Karnati, Naperville, IL (US)

(21) Appl. No.: 19/318,847

(22) Filed: Sep. 4, 2025

Related U.S. Application Data
(60) Provisional application No. 63/691,464, filed on Sep. 6, 2024.

(51) Int. Cl. B03D 1/016

(52) U.S. Cl. CPC B03D 1/016; B03D 2203/02

(57) ABSTRACT

Methods of improving the yield and/or purity of a mineral product obtained from a mineral ore comprise, consist essentially of, or consist of combining a cationic copolymer with a mineral ore or a mineral ore process stream to form a treated mineral ore or a treated mineral ore process stream; and processing the treated mineral ore or treated mineral ore process stream to collect a mineral product therefrom. The cationic copolymers are copolymers of N,N-dimethyl-N-propenyl-2-propen-1-aminium chloride (DADMAC).

### BACKGROUND

Production of minerals from ore is generally energy intensive and costly. Despite using methods often refined for well over a century, there are still many industry challenges to improve mineral production processes. In particular, use of increasingly lower grade ores of lower available product content and greater mineral complexity present an ongoing need for processes and materials to maximize product yield, conserve energy, and minimize operational costs. Attempts to meet these targets are increasingly faced with complicating factors in the use of low-grade ores. For example, higher levels of impurities capable of “poisoning” the process may become increasingly prevalent as lower grade ores are mined. Continuous mineral purification processes lead to recycling and possible concentration of high levels of impurities obtained from low grade ores, further reducing yield where one or more of the impurities cause poisoning.

Native impurities found in mineral ores often include organic (carbon-based) compounds. These native organic compounds, or NOC, are carbon-based compounds typically including carboxyl and hydroxyl moieties, as well as other moieties characterized by carbon-heteroatom bonds, including e.g. C—N bonds and C—S bonds. The type and concentration of NOCs that have been identified in various ores globally are reflective of their geographical source, and often include one or more of: alkanols, diols, phenols, polyhydroxylated polymeric and non-polymeric compounds including sugars and polysaccharides as well as phenolic polymers such as lignin and byproducts thereof; polybasic acids, hydroxyacids, polyhydroxy acids, and polyhydroxylated/polycarboxylated organic compounds such as humic substances (including humus acid, humic acid, hymatomelanic acid, fulvic acid, and humin); and chelates, complexes, and supramolecular structures formed form these.

Such NOC may interact with the components of and/or under the conditions of a mineral purification process when present in a mineral ore process stream, such as an extraction process stream for extracting mineral product from a mineral ore, or a separation process stream for separating a mineral product from other ore components.

In one such example of such an NOC interaction with a mineral ore process stream, some or all of the compounds listed above may be present in a bauxite ore; wherein processing of the bauxite ore at high pH employing the carboxylic acid groups present in an NOC are converted to sodium carboxylates during the high pH Bayer digestion process. Of these sodium carboxylates, sodium oxalate (Na₂C₂O₄) has been identified as highly detrimental to the Bayer process, acting to severely inhibit operations as evidenced by the plethora of art surrounding isolation and separation of oxalate species from Bayer liquors. In other systems, NOC salts act as surfactants in the system, changing the solubility of materials within the system and e.g. preventing precipitation of desirable mineral product(s).

Accordingly, NOC present in a mineral ore can affect yield of desirable mineral product obtained from a mineral ore process stream in one or more of three ways: first, by their presence, which reduces mineral yield directly; second, by affecting relative solubility of the mineral product in a mineral ore process stream, thereby reducing the ability to effectively separate the mineral product from the process stream; and third, by causing further undesirable side reactions that interfere with operability of the chemical process to produce yield, that is, by “poisoning” the system.

It is understood by those of skill that NOC, and in particular hydroxylated organic compounds—can interact with the components of and/or under the conditions of conventional ore purification processes to inhibit mineral precipitation, reduce processing productivity, and/or adversely affect the purity of the produced minerals.

On an industrial scale, yield of extracted valuable mineral products, such as yield of alumina from bauxite via the Bayer process can be significantly reduced by the presence of NOC in the ore as-mined, or in the ore as purified: that is, many current purification methods are less than completely effective at removing NOC from the mineral ore process stream from which the mineral product is obtained.

Additionally, in solid liquid separation of lithium ores, ultra fine clay particulates cause an issue during purification, specifically regarding solid-liquid separation. Such ultra-fine particulates, having a particle size range of 20 microns or less, often do not settle or settle too slowly during a sedimentation process in an industrial setting. The production costs of lithium ores are principally affected by the price of the ores, which is less competitive than that of extracting lithium from brine. Thus, the extraction of lithium compounds from ores in particular must obtain a superior recovery rate to produce sufficient economy of the process. Other mineral ores suffer similar impurity and “poisoning” issues that interfere with or even prevent extraction and/or purification thereof.

Accordingly, there is an ongoing and increasing need to lower the organic carbon concentration and/or control the impact of organic impurities in mineral ore process streams. Separately, there is a need to provide flocculation and settling of fine clay particulates in lithium ore solid-liquid separation processes.

### SUMMARY OF THE INVENTION

Disclosed herein are methods of improving the yield and/or purity of a mineral product obtained from a mineral ore. More specifically, disclosed herein are methods of improved removal of native organic compounds (NOC) from a mineral ore, thereby improving the yield and/or purity of the mineral product obtained therefrom. In embodiments, the methods comprise, consist essentially of, or consist of combining a cationic copolymer with a mineral ore to form a treated mineral ore; and processing the treated mineral ore to collect a mineral product therefrom. In embodiments, 0.001% to 1% by weight of a cationic copolymer is added to a mineral ore to form a treated mineral ore. In other embodiments, the method comprises, consists essentially of, or consists of combining a cationic copolymer with a mineral ore process stream to form a treated mineral ore process stream; and processing the treated mineral ore process stream to collect a mineral product therefrom. In embodiments, 0.01% to 1% by weight of a cationic copolymer is added to a mineral ore process stream. In embodiments, two or more cationic copolymers are added to a mineral ore or a mineral ore process stream, wherein the two or more cationic copolymers differ by chemical structure, molecular weight, or both chemical structure and molecular weight.

In embodiments, the cationic copolymer comprises one or more repeat units having structure I; and one or more repeat units selected from structure II, structure III, structure IV, or any combination thereof,

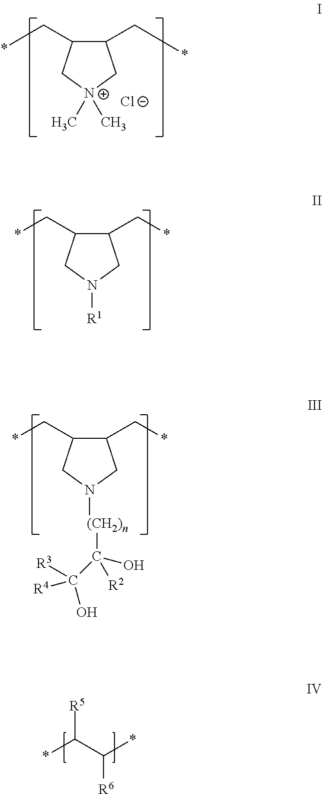

wherein n is an integer between 1 and 6; R¹ is a polymeric moiety comprising one or more repeat units having structure V;

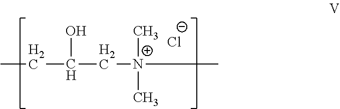

R², R³, and R⁴ are independently selected from hydrogen, C1-C10 alkyl moieties, and C2-C30 hydroxyalkyl moieties; R⁵ is hydrogen or methyl; and R⁶ is selected from C6-C30 hydrocarbyl, aralkyl, or alkaryl moieties, C6-C30 alkanoate moieties, alkylene ether moieties, or a combination of two or more of these.

In embodiments, the cationic copolymer includes at least 50 mole % repeat units having structure I. That is, 50% or more of the repeat units of the cationic copolymer are repeat units having structure I. Structure I is a repeat unit derived from N,N-dimethyl-N-propenyl-2-propen-1aminium chloride, CAS No. 48042-45-1, commonly referred to as diallyldimethylammonium chloride, or DADMAC. In embodiments, the cationic copolymer further includes one or more repeat units derived from one or more additional monomers, which include any one or more compounds including at least one a, 0-unsaturated functionality. In embodiments, the one or more additional monomers are anionic, cationic, noninonic, or betaine type monomers including but not limited to acrylic acid or a conjugate base thereof, methacrylic acid or a conjugate base thereof, acrylamide, methacrylamide, methylolacrylamide, styrene, allylamine, diallylamine, triallylamine, maleic acid or a conjugate base thereof, or itaconic acid or a conjugate base thereof.

Also disclosed herein are treated mineral ore compositions for improving the yield and/or purity of a mineral product obtained from a mineral ore. The treated mineral ore compositions are treated mineral ores, or treated mineral ore process streams. The treated mineral ores comprise, consist essentially of, or consist of a combination of a cationic copolymer with a mineral ore. The treated mineral ore process streams comprise, consist essentially of, or consist of a combination of a cationic copolymer with a mineral ore process stream. In any one or more embodiments herein, a mineral ore process stream comprises, consists essentially of, or consists of a mineral ore and water. In any one or more embodiments herein, a mineral ore process stream comprises, consists essentially of, or consists of between 10 wt % and 90 wt % water. In any one or more embodiments herein, a treated mineral ore process stream comprises, consists essentially of, or consists of 0.01% to 1% by weight of a cationic copolymer in a mineral ore process stream.

In any one or more embodiments herein, the mineral ore is a comminuted mineral ore, wherein the mineral ore is comminuted prior to combining with the one or more cationic copolymers, for example by grinding or milling. In any one or more embodiments herein, the mineral ore is comminuted prior to forming a mineral ore process stream, that is, prior to adding water to the comminuted ore. In any one or more embodiments herein the mineral ore is a reacted and/or extracted mineral ore.

In some embodiments, the mineral ore is a bauxite ore, and the mineral product is alumina trihydrate (alumina). In some embodiments, the mineral ore is a spodumene ore, and the mineral product is spodumene (LiAlSi₂O₆). In some embodiments, the mineral ore is a rock matrix or a heavy mineral sands ore bearing one or more of the following mineral products: gold, silver, copper, platinum, molybdenum, cobalt, iron, zirconium, titanium, thorium tungsten, rare earth elements, diamond, sapphire, garnet.

In any one or more embodiments herein, the total organic content (TOC) of a mineral product obtained in accordance with any one or more of the foregoing methods, is at least 0.5% lower by weight and as much as 50% lower by weight than the TOC of the mineral product obtained from the same mineral ore using the same methods, but without adding a cationic copolymer. In any one or more embodiments herein, the total organic content (TOC) of a mineral product obtained in accordance with any one or more of the foregoing treated mineral ore compositions is at least 0.1% lower by weight and as much as 50% lower by weight than the TOC of the mineral product obtained from the same mineral ore using the same mineral ore compositions, except that the mineral ore compositions include a DADMAC homopolymer instead of a cationic copolymer.

In any one or more embodiments herein, the yield of a mineral product obtained in accordance with any one or more of the foregoing methods is at least 0.5% by weight greater and as much as 50% by weight greater than the yield of the mineral product obtained from the same mineral ore using the same methods, but without adding a cationic copolymer. In any one or more embodiments herein, the yield of a mineral product obtained in accordance with any one or more of the foregoing treated mineral ore compositions is at least 0.1% by weight greater and as much as 50% by weight greater than the yield of the mineral product obtained from the same mineral ore using the same mineral ore compositions, except that the mineral ore compositions include a DADMAC homopolymer instead of a cationic copolymer.

Other objects and features will be in part apparent and in part pointed out hereinafter.

### DETAILED DESCRIPTION

Although the present disclosure provides references to preferred embodiments, persons skilled in the art will recognize that changes may be made in form and detail without departing from the spirit and scope of the invention. Various embodiments will be described in detail with reference to the drawings, wherein reference to various embodiments does not limit the scope of the claims attached hereto. Additionally, any examples set forth in this specification are not intended to be limiting and merely set forth some of the many possible embodiments for the appended claims.

### Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

As used herein, “mineral ore” means a solid rock material excavated from the earth and including a commercially valuable amount of one or more minerals within the rock matrix, or present as a particulate mixture thereof, wherein at least one purification or separation step or process is required to separate a mineral product from one or more native organic compounds also present in the mineral ore. A mineral ore may be “as-mined”, that is, in the form in which it was excavated from the earth; or the mineral ore may be comminuted, as determined by context and/or by selection of an operator of a mineral purification and/or separation process.

As used herein, “mineral product” refers to the commercially valuable product obtained from a mineral ore by carrying out one or more mineral ore processing methods.

As used herein, “organic compound” means a compound including one or more carbon atoms and one or more atoms selected from hydrogen, oxygen, nitrogen, or any combination thereof.

As used herein, the terms “native” and like terms referring to a source of a material or a compound indicates that the material or compound is obtained by excavating an ore, and is present in the ore product as excavated and prior to any processing of the ore. Additionally, such terms refer to the degradation products of materials or compounds within the ore product as further obtained within, or during, a mineral purification process.

As used herein, the term “process stream” means any aqueous liquid disposed within, added to, or for addition to processing equipment used for treating a mineral ore, thermochemically converting one or more compounds in a mineral ore, dissolving one or more compounds in a mineral ore, extracting one or more compounds from a mineral ore, separating one or more mineral products from a mineral ore, purifying one or more mineral products, and/or subjecting one or more purified mineral products or other compounds to further processing (such as calcining, alloying, and the like). A process stream includes at least water; in some embodiments a process stream consists essentially of or consists of water.

As used herein, the term “mineral ore process stream” means a process stream including a mineral ore or a comminuted and/or reacted and/or extracted mineral ore dispersed or dissolved therein, wherein at least one purification or separation step or process is required to separate a mineral product from one or more native organic compounds also present in the mineral ore process stream.

As used herein, the terms “soluble”, “dissolved” “dispersible” and similar terms as applied to a compound in a liquid means 1 wt % or more of the compound is completely solvated and homogeneously dispersed within the liquid, or is capable of becoming completely solvated and homogeneously dispersed in the liquid, without undergoing phase separation at 15° C./1 atm.

As used herein, terms applied to unsaturated polymerizable compounds such as “acrylic acid” or “DADMAC” refer to either the compound itself, that is, the monomer; or to the repeat unit derived by polymerization thereof, as determined by context.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of’ and “consisting essentially of,” the embodiments or elements presented herein, whether explicitly set forth or not.

As used herein, the term “optional” or “optionally” means that the subsequently described event or circumstance may but need not occur, and that the various embodiments of the description include instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5” and “about 1 to about 5” and “1 to about 5” and “about 1 to 5” unless specifically limited by context.

As used herein, “substantially” means “consisting essentially of”, as that term is construed in U.S. patent law, and includes “consisting of” as that term is construed in U.S. patent law. For example, a solution that is “substantially free” of a specified compound or material may be free of that compound or material, or may have a minor amount of that compound or material present, such as through unintended contamination, side reactions, or incomplete purification. A “minor amount” may be a trace, an unmeasurable amount, an amount that does not interfere with a value or property, or some other amount as provided in context. A composition that has “substantially only” a provided list of components may consist of only those components, or have a trace amount of some other component present, or have one or more additional components that do not materially affect the properties of the composition. Additionally, “substantially” modifying, for example, the type or quantity of an ingredient in a composition, a property, a measurable quantity, a method, a value, or a range, employed in describing the embodiments of the disclosure, refers to a variation that does not affect the overall recited composition, property, quantity, method, value, or range thereof in a manner that negates an intended composition, property, quantity, method, value, or range. Where modified by the term “substantially” the claims appended hereto include equivalents according to this definition.

As used herein, any recited ranges of values contemplate all values within the range and are to be construed as support for claims reciting any sub-ranges having endpoints which are real number values within the recited range. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

### DISCUSSION

Disclosed herein are methods of increasing the yield and/or purity of a mineral product obtained from a mineral ore; and methods of increasing the removal of native organic compounds (NOC) from a mineral ore process stream. In embodiments, a method comprises, consists essentially of, or consists of combining one or more cationic copolymers with a mineral ore to form a treated mineral ore; and processing the treated mineral ore to collect a mineral product therefrom. In embodiments, a method comprises, consists essentially of, or consists of combining one or more cationic copolymers with a mineral ore process stream to form a treated mineral ore process stream; and processing the treated mineral ore process stream to collect a mineral product therefrom.

In embodiments, one, two, three, or more cationic copolymers are added at one, two, three, or more points in a single mineral ore process stream to obtain increased yield and/or decreased total organic carbon content of a mineral product obtained from the mineral ore in accordance with the foregoing methods.

Accordingly, disclosed herein are cationic copolymers that are useful in conjunction with the foregoing methods for increasing the yield and/or decreasing total organic carbon content of a mineral product obtained from a mineral ore when used in accordance with the foregoing methods.

Also disclosed herein are treated mineral ores comprising, consisting essentially of, or consisting of a mineral ore combined with one or more cationic copolymers. Also disclosed herein are treated mineral ore process streams comprising, consisting essentially of, or consisting of a mineral ore process stream combined with one or more cationic copolymers.

### First Embodiments

In first embodiments, cationic copolymers useful for increasing the yield of a mineral product obtained from a mineral ore or a mineral ore process stream, and/or decreasing total organic carbon content of a mineral product obtained from a mineral ore or a mineral ore process stream are disclosed. In first embodiments, the cationic copolymer is a copolymer of N,N-dimethyl-N-propenyl-2-propen-1aminium chloride, CAS No. 48042-45-1, commonly referred to as DADMAC.

Accordingly, in any one or more first embodiments herein, the cationic copolymer comprises one or more repeat units having structure I, which is a DADMAC repeat unit; and one or more functionalized repeat units. In any one or more first embodiments herein the one or more functionalized repeat units are selected from polymer-grafted repeat units, which are repeat units having a polymer grafted thereto; repeat units having a hydrophobic group; repeat units having a polyhydroxylated group; and combinations of these. In any one or more first embodiments herein the one or more functionalized repeat units are selected from structure II, structure III, structure IV, or any combination thereof:

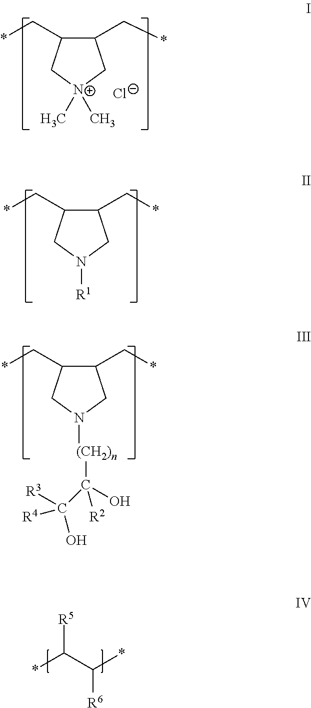

wherein n is an integer between 1 and 6, R¹ is a polymeric moiety comprising one or more repeat units having structure V,

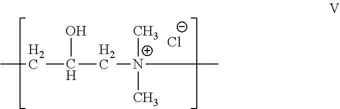

R², R³, and R⁴ are independently selected from hydrogen, C1-C10 alkyl moieties, and C2-C30 hydroxyalkyl moieties; R⁵ is hydrogen or methyl; and R⁶ is a C6-C30 hydrocarbyl moiety, a C8-C30 alkaryl or aralkyl moiety, an alkylene ether moiety including 3 to 16 ethylene oxide repeat units and/or 1 to 10 propylene oxide repeat units, or a moiety that includes both hydrocarbyl groups and alkylene ether groups, or both aralkyl groups and alkylene ether groups, or both alkaryl groups and alkylene ether groups.

In any one or more first embodiments herein, the cationic copolymer includes one or more repeat units having structure I, and one or more repeat units having an ionic polymer grafted thereto, wherein one or more of the polymer-grafted repeat units are repeat units having structure II; one or more repeat units having a polyhydroxylated group, wherein one or more of the repeat units having a polyhydroxylated group are repeat units having structure III; and/or one or more repeat units having a hydrophobic group, wherein one or more of the repeat units having a hydrophobic group are repeat units having structure IV.

In any one or more first embodiments herein, the cationic copolymer includes at least 10 mole % DADMAC; that is, at least 10% of the repeat units of the cationic copolymer are repeat units having structure I. In any one or more embodiments herein, the cationic copolymer includes up to 90 mole % DADMAC. For example, in any one or more embodiments herein, at least 10% of the repeat units of the cationic copolymer are repeat units having structure I; in some such embodiments 10% to 15%, or 15% to 20%, or 20% to 25%, or 25% to 30%, or 30% to 35%, or 35% to 40%, or 40% to 45%, or 45% to 50%, or 50% to 55%, or 55% to 60%, or 60% to 65%, or 65% to 70%, or 70% to 75%, or 75% to 80%, or 80% to 85%, or 85% to 90% of the repeat units of the cationic copolymer are repeat units having structure I. In any one or more first embodiments herein, the one or more repeat units having structure I is 1 to 1×10⁶ repeat units having structure I, such as 1-10, 10-100, 10-1000, 100-1000, 1000-1×10⁴, 1-5, 5-10, 10-50, 50-100, 100-150, 150-200, 200-300, 300-400, 400-500, 500-1000, 1000-1500, 1500-2000, 2000-3000, 3000-4000, 4000-5000, 5000-1×10⁴, 1×10⁴ to 1×10⁵, or 1×10⁵ to 1×10⁶ repeat units having structure I.

In some first embodiments herein, the cationic copolymer comprises, consists essentially of, or consists of repeat units having structures I and an II. In some first embodiments herein, the cationic copolymer comprises, consists essentially of, or consists of repeat units having structures I and III. In some first embodiments herein, the cationic copolymer comprises, consists essentially of, or consists of repeat units having structures I and IV. In some first embodiments herein, the cationic copolymer comprises, consists essentially of, or consists of repeat units having structures I, II, and IV. In some first embodiments herein, the cationic copolymer comprises, consists essentially of, or consists of repeat units having structures I, III, and IV. In some first embodiments herein, the cationic copolymer comprises, consists essentially of, or consists of repeat units having structures I, II, and III. In some first embodiments herein, the cationic copolymer excludes repeat units having structures II. In some first embodiments herein, the cationic copolymer excludes repeat units having structures III. In some first embodiments herein, the cationic copolymer excludes repeat units having structure IV. In some first embodiments herein, the cationic copolymer excludes repeat units having structures II or III. In some first embodiments herein, the cationic copolymer excludes repeat units having structures II or IV. I In some first embodiments herein, the cationic copolymer excludes repeat units having structures III or IV. In some first embodiments herein, the cationic copolymer comprises, consists essentially of, or consists of repeat units having structures I, II, III, and IV.

In any one or more first embodiments herein, repeat units having structure I and are arranged within the cationic copolymer in random, alternating, or block fashion with respect to the one or more repeat units having structures II, III, and/or IV. In any one or more first embodiments herein, the total number of repeat units I, II, II, and IV in the cationic copolymer is between 10 and 1×10⁷, such as 10-100, 10-1000, 100-1000, 1000-1×10⁴, 1-5, 5-10, 10-50, 50-100, 100-150, 150-200, 200-300, 300-400, 400-500, 500-1000, 1000-1500, 1500-2000, 2000-3000, 3000-4000, 4000-5000, 5000-1×10⁴, 1×10⁴ to 1×10⁵, 1×10⁵ to 1×10⁶, or 1×10⁶ to 1×10⁷ repeat units I, II, II, and IV in the cationic copolymer.

In any one or more first embodiments herein, the cationic copolymer comprises one or more repeat units having a polymer-grafted repeat unit, such as a repeat unit having structure II. In any one or more first embodiments herein, the cationic copolymer comprises 1 to 1×10⁶ repeat units II, such as 1-10, 10-100, 10-1000, 100-1000, 1000-1×10⁴, 1-5, 5-10, 10-50, 50-100, 100-150, 150-200, 200-300, 300-400, 400-500, 500-1000, 1000-1500, 1500-2000, 2000-3000, 3000-4000, 4000-5000, 5000-1×10⁴, 1×10⁴ to 1×10⁵, or 1×10⁵ to 1×10⁶ repeat units II. In any one or more embodiments of the repeat unit of structure II herein, the cationic copolymer comprises a ratio of the one or more repeat units having structure I to the one or more repeat units having structure II that is 100:1 to 1:100, for example 50:1 to 1:100, or 100:1 to 1:50, or 40:1 to 1:100, or 100:1 to 1:40, or 30:1 to 1:100, or 100:1 to 1:30, or 20:1 to 1:100, or 100:1 to 1:20, or 10:1 to 1:100, or 100:1 to 1:10, or 5:1 to 1:100, or 100:1 to 1:5, or 1:1 to 1:100, or 100:1 to 1:1, or 50:1 to 1:50, or 40:1 to 1:40, or 30:1 to 1:30, or 20:1 to 1:20, or 10:1 to 1:10, or 5:1 to 1:5, or 2:1 to 1:2, or 10:1 to 1:1, or 1:1 to 1:10, or 5:1 to 1:1, or 1:1 to 1:5, or 2:1 to 1:1, or 1:1 to 1:2, or about 100:1, or about 50:1, or about 40:1, or about 30:1, or about 20:1, or about 10:1, or about 5:1, or about 4:1, or about 3:1, or about 2:1, or about 1:1, or about 1:2, or about 1:3, or about 1:4, or about 1:5, or about 1:10, or about 1:20, or about 1:30, or about 1:40, or about 1:50, or about 1:100.

In any one or more embodiments of the repeat unit having structure II herein, R¹ is a polymeric moiety comprising one or more repeat units having structure V. Accordingly, the repeat unit having structure II is one example of a polymer-grafted repeat unit, specifically a cationic polymer-grafted repeat unit. In some embodiments herein, the repeat unit having structure II is attributable to the reaction of epichlorohydrin with diallylamine, and further condensation of dimethylamine and epichlorohydrin with the diallylamine-epichlorohydrin reaction product, to result in a poly(epichlorohydrin-dimethylamine) (or “epi-DMA”) grafted diallylamine monomer; and finally, copolymerization of the epi-DMA grafted diallylamine monomer with DADMAC to form a cationic copolymer that includes repeat units I and II. In other embodiments of the repeat unit having structure II herein, a DADMAC—diallylamine copolymer is reacted with epichlorohydrin and dimethylamine to result in a cationic copolymer that includes repeat units I and II.

In any one or more embodiments of the repeat unit of structure II herein, each repeat unit II includes R¹ that comprises, consists essentially of, or consists of 3 to 1×10⁶ repeat units V such as 3-10, 10-100, 10-1000, 100-1000, 1000-1×10⁴, 3-5, 5-10, 10-50, 50-100, 100-150, 150-200, 200-300, 300-400, 400-500, 500-1000, 1000-1500, 1500-2000, 2000-3000, 3000-4000, 4000-5000, 5000-1×10⁴, 1×10⁴ to 1×10⁵, or 1×10⁵ to 1×10⁶ repeat units V. In any one or more embodiments herein, the molar ratio of repeat units having structure I (DADMAC) to repeat units having structure V (epi-DMA) is between 5:1 and 1:5, for example 5:1 to 1:4, or 5:1 to 1:3, or 5:1 to 1:2, or 5:1 to 1:1, or 4:1 to 1:5, or 3:1 to 1:5, or 2:1 to 1:5, or 1:1 to 1:5, or about 5:1, or about 4:1, or about 3:1, or about 2:1, or about 1:1, or about 1:2, or about 1:3, or about 1:4, or about 1:5.

In any one or more first embodiments herein, the cationic copolymer comprises one or more repeat units having a polyhydroxylated repeat unit, such as a repeat unit having structure III. In any one or more embodiments of the repeat unit having structure III herein, n is 1. In any one or more embodiments of the repeat unit having structure III herein, R², R³, and R⁴ are each hydrogen. In any one or more embodiments of the repeat unit having structure III herein, n is 1 and R², R³, and R⁴ are each hydrogen. In any one or more embodiments of the repeat unit having structure III herein, R³, R⁴, or both R³ and R⁴ are C3-C10 hydroxyalkyl moieties including 3, 4, 5, 6, 7, 8, 9, or 10 carbons and at least one hydroxyl group bonded thereto. In some such embodiments, a C3-C10 hydroxyalkyl moiety includes 2 to 6 hydroxyl groups bonded thereto, that is, 2, 3, 4, 5, or 6 hydroxyl groups bonded thereto.

In any one or more first embodiments herein, the cationic copolymer comprises one or more repeat units having structure I and one or more repeat units having a polyhydroxylated repeat unit, such as a repeat unit having structure III. In any one or more first embodiments herein, the cationic copolymer comprises one or more repeat units having structure I and one or more repeat units having structure IIIa, which is derived from polymerization of 2,3-dihydroxypropyldiallylamine. Accordingly, 2,3-dihydroxypropyldiallylamine is formed by reacting diallylamine with glycidol in a 1:1 molar ratio.

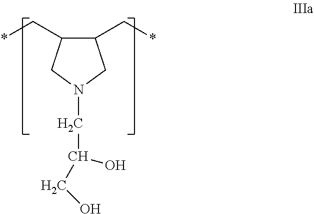

In any one or more embodiments of the repeat unit having structure III herein, an hydroxy-functionalized diallylamine monomer (such as 2,3-dihydroxypropyldiallylamine) is copolymerized with at least DADMAC to form a cationic copolymer repeat unit having structure III (such as IIIa). In any one or more embodiments of the repeat unit having structure III herein, the hydroxy-functionalized monomer is synthesized by reacting diallylamine with glycidol.

In any one or more first embodiments herein, the cationic copolymer comprises 1 to 1×10⁶ polyhydroxylated repeat units, such as repeat units III, such as 1-10, 10-100, 10-1000, 100-1000, 1000-1×10⁴, 1-5, 5-10, 10-50, 50-100, 100-150, 150-200, 200-300, 300-400, 400-500, 500-1000, 1000-1500, 1500-2000, 2000-3000, 3000-4000, 4000-5000, 5000-1×10⁴, 1×10⁴ to 1×10⁵, or 1×10⁵ to 1×10⁶ repeat units III. In any one or more first embodiments herein, the cationic copolymer comprises a ratio of the one or more repeat units having structure I to the one or more repeat units having structure III that is between 100:1 and 1:100, for example 50:1 to 1:100, or 100:1 to 1:50, or 40:1 to 1:100, or 100:1 to 1:40, or 30:1 to 1:100, or 100:1 to 1:30, or 20:1 to 1:100, or 100:1 to 1:20, or 10:1 to 1:100, or 100:1 to 1:10, or 5:1 to 1:100, or 100:1 to 1:5, or 1:1 to 1:100, or 100:1 to 1:1, or 50:1 to 1:50, or 40:1 to 1:40, or 30:1 to 1:30, or 20:1 to 1:20, or 10:1 to 1:10, or 5:1 to 1:5, or 2:1 to 1:2, or 10:1 to 1:1, or 1:1 to 1:10, or 5:1 to 1:1, or 1:1 to 1:5, or 2:1 to 1:1, or 1:1 to 1:2, or about 100:1, or about 50:1, or about 40:1, or about 30:1, or about 20:1, or about 10:1, or about 5:1, or about 4:1, or about 3:1, or about 2:1, or about 1:1, or about 1:2, or about 1:3, or about 1:4, or about 1:5, or about 1:10, or about 1:20, or about 1:30, or about 1:40, or about 1:50, or about 1:100.

In any one or more first embodiments herein, the cationic copolymer comprises one or more repeat units having a hydrophobic group, such as a repeat unit having structure IV. In any one or more embodiments of the repeat unit having structure IV herein, R⁵ is methyl or hydrogen. In any one or more embodiments of the repeat unit having structure IV herein, R⁶ is a C6-C30 hydrocarbyl moiety, a C8-C30 alkaryl or aralkyl moiety, an alkylene ether moiety including 3 to 16 ethylene oxide repeat units and/or 1 to 10 propylene oxide repeat units, or a moiety that includes both hydrocarbyl groups and alkylene ether groups, or both aralkyl groups and alkylene ether groups, or both alkaryl groups and alkylene ether groups. In any one or more embodiments of the repeat unit having structure IV herein, R⁶ is a hydrocarbyl moiety including 6, 7, 8, 9, 10, 11, 12, 13, 14, 15, 16, 17, 18, 19, 20, 21, 22, 23, 24, 25, 26, 27, 28, 29, or 30 carbons. In any one or more embodiments of the repeat unit having structure IV herein, R⁶ is an aralkyl or alkaryl moiety including 8, 9, 10, 11, 12, 13, 14, 15, 16, 17, 18, 19, 20, 21, 22, 23, 24, 25, 26, 27, 28, 29, or 30 carbons. In some embodiments of the repeat unit having structure IV herein, R⁶ is a saturated, linear, or saturated and linear hydrocarbyl moiety. In some embodiments of the repeat unit having structure IV herein, R⁶ is an alkaryl moiety. In some embodiments of the repeat unit having structure IV herein, R⁶ is a C6-C30 saturated or unsaturated alkanoate moiety, such as a decanoate, dodecanoate, oleate or stearate moiety.

In some embodiments of the repeat unit having structure IV herein, the repeat unit having structure IV is a repeat unit having structure IVa or structure IVb:

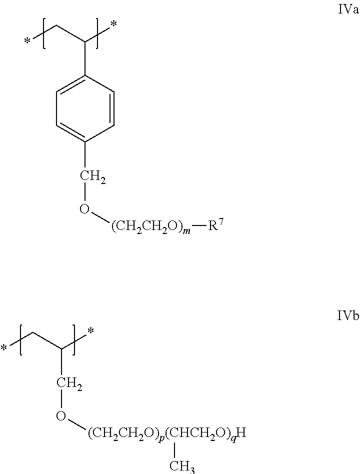

wherein m, p, and q are independently integers between 1 and 20 and R⁷ is a hydrocarbyl, aralkyl or alkaryl moiety including 8, 9, 10, 11, 12, 13, 14, 15, 16, 17, 18, 19, 20, 21, 22, 23, 24, 25, 26, 27, 28, 29, or 30 carbons. In some embodiments of the repeat unit having structure IVa, alkylene oxide repeat units p and q are present in a random, alternating, or block arrangement. In some embodiments of the repeat unit having structure IVa, m is 5-12, and R⁷ is a linear C8-C16 hydrocarbyl moiety. In some embodiments of the repeat unit having structure IVa, m is 9 and R⁷ is a linear C12 hydrocarbyl moiety. In some embodiments of the repeat unit having structure IVb, p is 8-16 and q is 2-6. In some embodiments of the repeat unit having structure IVb, p is 11 and q is 4.

In any one or more first embodiments herein, the cationic copolymer comprises 1 to 1×10⁶ repeat units IV, such as 1-10, 10-100, 10-1000, 100-1000, 1000-1×10⁴, 1-5, 5-10, 10-50, 50-100, 100-150, 150-200, 200-300, 300-400, 400-500, 500-1000, 1000-1500, 1500-2000, 2000-3000, 3000-4000, 4000-5000, 5000-1×10⁴, 1×10⁴ to 1×10⁵, or 1×10⁵ to 1×10⁶ repeat units IV. In any one or more first embodiments herein, the cationic copolymer comprises a ratio of the one or more repeat units having structure I to the one or more repeat units having structure IV that is between 100:1 and 1:100, for example 50:1 to 1:100, or 100:1 to 1:50, or 40:1 to 1:100, or 100:1 to 1:40, or 30:1 to 1:100, or 100:1 to 1:30, or 20:1 to 1:100, or 100:1 to 1:20, or 10:1 to 1:100, or 100:1 to 1:10, or 5:1 to 1:100, or 100:1 to 1:5, or 1:1 to 1:100, or 100:1 to 1:1, or 50:1 to 1:50, or 40:1 to 1:40, or 30:1 to 1:30, or 20:1 to 1:20, or 10:1 to 1:10, or 5:1 to 1:5, or 2:1 to 1:2, or 10:1 to 1:1, or 1:1 to 1:10, or 5:1 to 1:1, or 1:1 to 1:5, or 2:1 to 1:1, or 1:1 to 1:2, or about 100:1, or about 50:1, or about 40:1, or about 30:1, or about 20:1, or about 10:1, or about 5:1, or about 4:1, or about 3:1, or about 2:1, or about 1:1, or about 1:2, or about 1:3, or about 1:4, or about 1:5, or about 1:10, or about 1:20, or about 1:30, or about 1:40, or about 1:50, or about 1:100.

In any one or more first embodiments herein, the cationic copolymer optionally further includes one or more additional repeat units derived from one or more additional monomers, wherein the one or more additional monomers are selected from a, β-unsaturated compounds including but not limited to acrylic acid or a conjugate base thereof, methacrylic acid or a conjugate base thereof, acrylamide, methacrylamide, methylolacrylamide, styrene, allylamine, diallylamine, triallylamine, maleic acid or a conjugate base thereof, or itaconic acid or a conjugate base thereof. In embodiments where one or more additional repeat units are included in a cationic copolymer, between 0.01% and 20% repeat units attributable to the total of the one or more additional monomers, for example 0.1% to 20%, or 1% to 20%, or 5% to 20%, or 10% to 20%, or 15% to 20%, or 0.01% to 15%, or 0.01% to 10%, or 0.01% to 5%, or 0.01% to 1%, or 0.01% to 0.1%, or 0.1% to 1%, or 1% to 5%, or 5% to 10%, or 10% to 15%, or 15% to 20% repeat units attributable to the total of the one or more additional monomers.

In any one or more first embodiments herein, the cationic copolymers are formed by copolymerizing DADMAC monomer with the selected comonomer(s) in the selected ratio, employing any of several techniques reported in the literature for synthesis of DADMAC homopolymers. In any one or more embodiments of a cationic copolymer including one or more repeat units having structure II, the repeat unit having structure V is synthesized by condensing diallylamine with epichlorohydrin and dimethylamine in a desired ratio and amount, then copolymerizing the “epi-DMA” functionalized diallylamine with DADMAC in a desired ratio and amount; or alternatively, copolymerizing diallylamine with DADMAC in a desired ratio and amount, then functionalizing the repeat units derived from the diallylamine by reacting the copolymer with epichlorohydrin and dimethylamine in a desired ratio and amount. In any one or more embodiments of a cationic copolymer including one or more repeat units having structure II, the cationic copolymer obtains a weight average or a number average molecular weight of about 1×10⁵ g/mol to about 3×10⁶ g/mol, often about 2×10⁵ g/mol to about 2×10⁶ g/mol; whereas a cationic copolymer excluding repeat units having structure II obtains a molecular weight of about 1×10⁴ g/mol to about 1×10⁶ g/mol, often about 5×10⁴ g/mol to about 5×10⁵ g/mol.

In any one or more first embodiments herein, one or more cationic copolymers are water soluble or water dispersible, and in some embodiments are dissolved or dispersed in water. In any one or more first embodiments herein, one or more cationic copolymers are soluble or dispersible in a mixture of water and one or more water-miscible cosolvents, for example one or more C1-C6 alkanols, ketones, aldehydes, esters, glycols, or glycol ethers; and in some embodiments are dissolved or dispersed in a water/cosolvent mixture. As used herein, the terms “soluble”, “dissolved” “dispersible” and similar terms as applied to a polymer in a liquid means 1 wt % or more of the polymer is completely solvated and homogeneously dispersed within the liquid, or is capable of becoming completely solvated and homogeneously dispersed in the liquid, without undergoing phase separation at 15° C./1 atm.

### Second Embodiments

In second embodiments herein, methods of using one or more cationic copolymers of first embodiments to increase yield of a mineral product obtained from a mineral ore, or reduce the amount of native organic compounds (NOC) associated with a mineral product obtained from a mineral ore are described, as well as treated mineral ores and treated mineral ore process streams obtained by the foregoing methods.

Accordingly, in some second embodiments, any one or more cationic copolymers of first embodiments are combined with a mineral ore to form a treated mineral ore; and the treated mineral ore is processed to obtain a mineral product therefrom. In some such second embodiments, 0.001% to 1% by weight of one or more cationic copolymers of first embodiments is combined with the mineral ore to form the treated mineral ore. In some such second embodiments, processing the treated mineral ore is adding the treated mineral ore to a process stream to form a treated mineral ore process stream; and collecting a mineral product from the treated mineral ore process stream.

In other second embodiments herein, 0.01% to 1% by weight of any one or more cationic copolymers of first embodiments is combined with a mineral ore process stream to form a treated mineral ore process stream; and the treated mineral ore process stream is processed to collect a mineral product therefrom.

In second embodiments herein, the mineral ore is a solid rock material excavated from the earth and bearing a commercially valuable amount of one or more minerals entrapped within the rock matrix, along with various organic and inorganic compounds from which the mineral is desirably separated to provide a mineral product. In some second embodiments herein, the mineral ore is a bauxite ore, and the mineral product is alumina trihydrate (alumina). In some second embodiments herein, the mineral ore is a lithium ore, and the mineral product is spodumene (LiAlSi₂O₆). In some second embodiments herein, the mineral ore is a rock matrix in which a commercially valuable amount of one or more of gold, silver, copper, molybdenum, cobalt, or iron is entrained. In some second embodiments herein, the mineral ore is a heavy mineral sands ore in which a commercially valuable amount of one or more of zirconium, titanium, thorium tungsten, rare earth elements, diamond, sapphire, garnet, gold, silver, copper, or platinum is entrained.

In any one or more second embodiments herein, the mineral ore is a comminuted mineral ore. In any one or more such second embodiments, comminuting comprises, consists essentially of, or consists of milling or grinding; in some such embodiments, the comminuted mineral ore is further classified to control ore particle size for processing and collection of a mineral product therefrom, in accordance with the knowledge of those having skill in the art of mineral ore processing. Such comminuting often targets mineral ore particle sizes of 3 mm or less, to about 50 microns (as determined by screen sieving) for addition to a process stream, for example 2 mm to 50 microns, or 1 mm to 50 microns, or 500 microns to 50 microns, or 3 mm to 100 microns, or 3 mm to 500 microns, or 3 mm to 1 mm, or 3 mm to 2 mm, or 50 microns to 100 microns, or 100 microns to 500 microns, or 500 microns to 1 mm, or 1 mm to 2 mm.

In any one or more second embodiments herein, the mineral ore is comminuted prior to combining with the one or more cationic copolymers. In any one or more second embodiments herein, the mineral ore is comminuted prior to forming a treated mineral ore, or prior to forming a mineral ore process stream, or prior to forming a treated mineral ore process stream. In any one or more second embodiments herein, the mineral ore is a comminuted mineral ore that has been further processed prior to the addition of the cationic copolymer and accordingly obtains a particle size that is less than 3 mm, often less than 1 mm, and in some embodiments about 1 micron to about 1 mm, for example 1 micron to 10 microns, or 5 microns to 10 microns, or 5 microns to 20 microns, or 10 microns to 20 microns, or 10 microns to 50 microns, or 20 microns to 50 microns, or 50 microns to 100 microns, or 100 microns to 500 microns, or 500 microns to 1 mm.

In any one or more second embodiments herein, a process stream used for processing a mineral ore is any aqueous liquid disposed within, added to, or for addition to processing equipment used for treating mineral ores, thermochemically converting one or more compounds in a mineral ore, extracting one or more compounds from a mineral ore, separating one or more mineral products from a mineral ore, purifying one or more mineral products, and/or subjecting one or more purified mineral products or other compounds to further processing. Accordingly, in any one or more second embodiments herein a process stream comprises, consists essentially of, or consists of water. In some second embodiments herein, a process stream further includes one or more cosolvents, for example one or more C1-C6 alkanols, ketones, aldehydes, esters, glycols, or glycol ethers. In some second embodiments herein, a process stream further includes one or more mineral processing materials conventionally added to mineral ore process streams, the specific additional materials being determined by one of skill based on the type of mineral ore to be processed and the types of processing steps to be carried out to obtain the mineral product from the process stream. Examples of such mineral processing materials include corrosion inhibitors and biocides for maintaining the conditions within the interior of the mineral processing equipment, including associated tanks, pipes or other conduits, valves, heating equipment, and other infrastructure; froth flotation components such as frothing agents, collectors, depressants, and froth modifiers; flocculants and/or coagulants for obtaining solid-liquid separations; reagents for thermochemical conversion and/or extraction of one or more mineral ore components, such as sodium hydroxide for conversion of aluminum compounds in bauxite ore to aluminate salts, or cyanide compounds for extracting high-value metals such as gold or silver from their respective ores.

In any one or more second embodiments herein, a mineral ore process stream is a process stream including a mineral ore or a comminuted and/or reacted and/or extracted product thereof, wherein at least one purification or separation step is needed to separate a mineral product from one or more native organic compounds. Native organic compounds, or NOC, are compounds including one or more carbon atoms and one or more atoms selected from hydrogen, oxygen, nitrogen, or any combination thereof, wherein the compound is obtained by excavating the mineral ore, and is present in the mineral ore as-mined, that is, as excavated and prior to any processing of the ore; or is present as a degradation, reaction, or rearrangement product product of such a compound, wherein the degradation product is obtained during or by any reacting and/or extracting of a mineral ore. NOC often including hydroxyl moieties and/or carboxyl moieties as well as other moieties characterized by carbon-heteroatom bonds, including e.g. C—N bonds and C—S bonds. Types of NOC previously identified in mineral ores include include alkanols, diols, phenols, polyhydroxylated polymeric and non-polymeric compounds including sugars and polysaccharides as well as phenolic polymers such as lignin and byproducts thereof; polybasic acids, hydroxyacids, polyhydroxy acids, and polyhydroxylated/polycarboxylated organic compounds such as humic substances (including humus acid, humic acid, hymatomelanic acid, fulvic acid, and humin); and chelates, complexes, and supramolecular structures formed form these.

In some embodiments, an NOC is a poison, that is, the NOC causes or is capable of causing a reduced yield of mineral product obtained in a mineral purification process, further wherein the yield of mineral product is reduced compared to the same conditions in the absence of the NOC. Thus, for example, the presence of 0.1 wt % of an organic compound in an ore is said to poison a mineral purification process where a reduced mineral yield attributable to the organic compound is greater than 0.1 wt %. That is, the effect of an NOC is to reduce mineral product yield by its presence; whereas the mineral product yield reduction of an NOC that is also a poison is greater than this amount. In some embodiments, the products of one or more NOC reactions that occur during the processing of a mineral ore are poisons; such reactions can be caused by the addition of chemicals to the ore, for example. In some such embodiments, the NOC is not a poison, but one or more NOC reaction products are poisons.

Even in embodiments where an NOC or NOC reaction product is not a poison, the effects of even small amounts of impurities in lowering yield of a mineral product is magnified by the continuous processes employed industrially for processing of mineral ores. In such processes, soluble materials including some NOCs or NOC reaction products may be carried forward in multiple process cycles, thereby exerting significant yield-lowering effects over the entirety of the continuous process. Accordingly, the cationic copolymers of first embodiments herein are usefully deployed within one or more mineral processing methods to obtain higher yield of the targeted mineral product, lower total organic carbon (TOC) in the targeted mineral product, or both lower TOC and higher yield of the targeted mineral product, compared to the yield and TOC of the mineral product obtained without adding a cationic copolymer of first embodiments; or obtained by adding e.g. DADMAC homopolymer instead of a cationic copolymer.

In any one or more second embodiments herein, a mineral ore present in a mineral ore process stream is a comminuted mineral ore. Further, in any one or more second embodiments herein, a mineral ore present in a mineral ore process stream is a reacted and/or extracted mineral ore, wherein one or more reagents have been added to the mineral ore or to the process stream that result in thermochemical conversion of one or more mineral ore components, often with the result that the converted components become soluble in the aqueous process stream, and thereby are extracted from the surrounding rock matrix by reaction followed by dissolution. Examples of extracted mineral ores in process streams include gold and silver ores present in a process stream including a sodium cyanide solution at pH of about 9 or above, in which the mineral product is extracted from the rock matrix. Examples of reacted and extracted mineral ores within a process stream include Bayer liquors, which include dissolved aluminate salts after digestion of a solid bauxite ore in a caustic process stream. Examples of extracted mineral ores within a process stream include gold-containing process streams obtained by applying a gold ore to a low pH or cyanide-containing process stream; and lithium ores which are comminuted and floated (subjected to froth flotation).

Accordingly, in any one or more second embodiments herein, a mineral ore present in a mineral ore process stream is a comminuted mineral ore, a reacted mineral ore, a comminuted and reacted mineral ore, an extracted mineral ore, a comminuted and extracted mineral ore, a reacted and extracted mineral ore, or a comminuted, reacted, and extracted mineral ore; wherein one or more NOC is present in the mineral ore process stream, and at least one purification or separation step is needed to separate a mineral product in the mineral ore process stream from one or more of the one or more NOC.

In any one or more second embodiments herein, a mineral ore process stream includes between 5 wt % and 80 wt % of a mineral ore or a comminuted and/or reacted and/or extracted product thereof, such as 10 wt % to 80 wt %, or 20 wt % to 80 wt %, or 50 wt % to 80 wt %, or 5 wt % to 50 wt %, or 5 wt % to 20 wt %, or 5 wt % to 10 wt %, or 10 wt % to 20 wt %, or 20 wt % to 30 wt %, or 30 wt % to 40 wt %, or 40 wt % to 50 wt %, or 50 wt % to 60 wt %, or 60 wt % to 70 wt %, or 70 wt % to 80 wt % of a mineral ore or a comminuted and/or reacted and/or extracted product thereof. In any one or more second embodiments herein, a mineral ore process stream includes between 20 wt % and 95 wt % water, such as 20 wt % to 90 wt %, or 20 wt % to 80 wt %, or 20 wt % to 60 wt %, or 20 wt % to 40 wt %, or 30 wt % to 95 wt %, or 40 wt % to 95 wt %, or 60 wt % to 95 wt %, or 80 wt % to 95 wt %, or 20 wt % to 30 wt %, or 30 wt % to 40 wt %, or 40 wt % to 50 wt %, or 50 wt % to 60 wt %, or 60 wt % to 70 wt %, or 70 wt % to 80 wt % water.

Accordingly, in any one or more second embodiments herein, a treated mineral ore process stream comprises, consists essentially of, or consists of one or more cationic copolymers of first embodiments herein combined with a mineral ore process stream. In any one or more second embodiments herein, a treated mineral ore process stream comprises, consists essentially of, or consists of 0.01% to 1.00% by weight of one or more cationic copolymers of first embodiments herein combined with a mineral ore process stream, such as 0.01 wt % to 0.90 wt %, or 0.01 wt % to 0.80 wt %, or 0.01 wt % to 0.70 wt %, or 0.01 wt % to 0.60 wt %, or 0.01 wt % to 0.50 wt %, or 0.01 wt % to 0.40 wt %, or 0.01 wt % to 0.30 wt %, or 0.01 wt % to 0.20 wt %, or 0.01 wt % to 0.10 wt %, or 0.01 wt % to 0.05 wt %, or 0.05 wt % to 1.00 wt %, or 0.10 wt % to 1.00 wt %, or 0.20 wt % to 1.00 wt %, or 0.30 wt % to 1.00 wt %, or 0.40 wt % to 1.00 wt %, or 0.50 wt % to 1.00 wt %, or 0.60 wt % to 1.00 wt %, or 0.70 wt % to 1.00 wt %, or 0.80 wt % to 1.00 wt %, or 0.90 wt % to 1.00 wt %, or 0.05 wt % to 0.10 wt %, or 0.10 wt % to 0.20 wt %, or 0.20 wt % to 0.30 wt %, or 0.30 wt % to 0.40 wt %, or 0.40 wt % to 0.50 wt %, or 0.50 wt % to 0.60 wt %, or 0.60 wt % to 0.70 wt %, or 0.70 wt % to 0.80 wt %, or 0.80 wt % to 0.90 wt % of one or more cationic copolymers of first embodiments herein combined with a mineral ore process stream.

Accordingly, in some second embodiments, 0.01% to 1.00% by weight of any one or more cationic copolymers of first embodiments is combined with a mineral ore process stream to form a treated mineral ore process stream; and the treated mineral ore process stream is processed to collect a mineral product therefrom. In such second embodiments, 0.01 wt % to 0.90 wt %, or 0.01 wt % to 0.80 wt %, or 0.01 wt % to 0.70 wt %, or 0.01 wt % to 0.60 wt %, or 0.01 wt % to 0.50 wt %, or 0.01 wt % to 0.40 wt %, or 0.01 wt % to 0.30 wt %, or 0.01 wt % to 0.20 wt %, or 0.01 wt % to 0.10 wt %, or 0.01 wt % to 0.05 wt %, or 0.05 wt % to 1.00 wt %, or 0.10 wt % to 1.00 wt %, or 0.20 wt % to 1.00 wt %, or 0.30 wt % to 1.00 wt %, or 0.40 wt % to 1.00 wt %, or 0.50 wt % to 1.00 wt %, or 0.60 wt % to 1.00 wt %, or 0.70 wt % to 1.00 wt %, or 0.80 wt % to 1.00 wt %, or 0.90 wt % to 1.00 wt %, or 0.05 wt % to 0.10 wt %, or 0.10 wt % to 0.20 wt %, or 0.20 wt % to 0.30 wt %, or 0.30 wt % to 0.40 wt %, or 0.40 wt % to 0.50 wt %, or 0.50 wt % to 0.60 wt %, or 0.60 wt % to 0.70 wt %, or 0.70 wt % to 0.80 wt %, or 0.80 wt % to 0.90 wt % of the one or more cationic copolymers of first embodiments is combined with the mineral ore process stream to form a treated mineral ore process stream; and the treated mineral ore process stream is processed to collect a mineral product therefrom.

In other second embodiments herein, 0.001% to 1% by weight of one or more cationic copolymers of first embodiments is combined with a mineral ore to form a treated mineral ore; and the treated mineral ore is added to a process stream to form a treated mineral ore process stream; and the treated mineral ore process stream is processed to collect a mineral product therefrom. In such second embodiments, 0.001 wt % to 0.90 wt %, or 0.001 wt % to 0.80 wt %, or 0.001 wt % to 0.70 wt %, or 0.001 wt % to 0.60 wt %, or 0.001 wt % to 0.50 wt %, or 0.001 wt % to 0.40 wt %, or 0.001 wt % to 0.30 wt %, or 0.001 wt % to 0.20 wt %, or 0.001 wt % to 0.10 wt %, or 0.001 wt % to 0.01 wt %, or 0.01 wt % to 1.00 wt %, or 0.10 wt % to 1.00 wt %, or 0.20 wt % to 1.00 wt %, or 0.30 wt % to 1.00 wt %, or 0.40 wt % to 1.00 wt %, or 0.50 wt % to 1.00 wt %, or 0.60 wt % to 1.00 wt %, or 0.70 wt % to 1.00 wt %, or 0.80 wt % to 1.00 wt %, or 0.90 wt % to 1.00 wt %, or 0.001 wt % to 0.01 wt %, or 0.01 wt % to 0.10 wt %, or 0.10 wt % to 0.20 wt %, or 0.20 wt % to 0.30 wt %, or 0.30 wt % to 0.40 wt %, or 0.40 wt % to 0.50 wt %, or 0.50 wt % to 0.60 wt %, or 0.60 wt % to 0.70 wt %, or 0.70 wt % to 0.80 wt %, or 0.80 wt % to 0.90 wt % of the one or more cationic copolymers of first embodiments is combined with a mineral ore to form a treated mineral ore; and the treated mineral ore is added to a process stream to form a treated mineral ore process stream; and the treated mineral ore process stream is processed to collect a mineral product therefrom.

In some second embodiments herein, the combining of the one or more cationic copolymers of first embodiments with a mineral ore to form a treated mineral ore is suitably accomplished using any one or more conventional techniques for addition of a polymeric compound to a mineral ore prior to adding the mineral ore to a process stream. In some embodiments, one or more cationic copolymers are mixed with water and optionally further one or more cosolvents to form a cationic copolymer solution or dispersion, as noted above; and the cationic copolymer solution or dispersion is admixed with the mineral ore by spraying, pumping, pouring, or the like, optionally while contemporaneously stirring or comminuting the ore, to obtain a treated mineral ore. The treated mineral ore is admixed with a process stream to form a treated mineral ore process stream.

In some second embodiments herein, the combining of the one or more cationic copolymers of first embodiments with a mineral ore process stream to form a treated mineral ore process stream is suitably accomplished using any one or more conventional techniques for addition of a polymeric compound to a mineral ore process stream or to a process stream (aqueous liquid). Accordingly, in some embodiments, one or more cationic copolymers are combined with a mineral ore process stream by introducing the one or more copolymers neat to the process stream, or to the mineral ore process stream, via an addition port or solids injection port located in fluid communication with the mineral ore process stream. In other embodiments, one or more cationic copolymers are mixed with water and optionally further one or more cosolvents, as noted above, to form a cationic copolymer solution or dispersion; and the cationic copolymer solution or dispersion is introduced to the process stream, or to the mineral ore process stream via an addition port or liquids injection port located in fluid communication with the process stream, or to the mineral ore process stream to result in a treated mineral ore process stream.

In any one or more second embodiments herein, processing a treated mineral ore process stream to collect a mineral product therefrom is accomplished using any one or more conventional mineral product collection processes employed by those of skill in collecting mineral products from mineral ores. Such processing conventionally includes one or more purification steps to remove NOC from a mineral ore processing stream. Accordingly, in any one or more second embodiments herein, a treated mineral ore process stream is subjected to at least one such purification step for removing NOC and/or other impurities from the mineral product. Exemplary purification steps include flotation, sedimentation, countercurrent flow, hydrocyclone, or filtration steps.

The removal of NOC from a mineral ore process stream is quantified by measuring the Total Organic Carbon of the mineral ore as-mined and comparing it to the Total Organic Carbon of collected mineral product collected using a standardized test procedure. The use of thermochemical methodology to analyze total organic content of ore materials is confirmed by Pulpeiro et al., Light Metals, 1998, 284. Accordingly, the amount of the one or more cationic copolymers added to a mineral ore, a process stream, or a mineral ore process stream may be selected by the operator to target the amount of TOC or NOC present in the mineral ore.

Accordingly, in any one or more second embodiments herein, after processing a treated mineral ore process stream to collect a mineral product therefrom, the total organic content (TOC) of the mineral product collected is at least 0.5% lower by weight and as much as 50% lower by weight than the TOC of the mineral product obtained from the same mineral ore process stream using the same processing method, but without adding a cationic copolymer in accordance with first embodiments, for example 0.5 wt % to 50 wt %, or 1 wt % to 50 wt %, or 2 wt % to 50 wt %, or 3 wt % to 50 wt %, or 4 wt % to 50 wt %, or 5 wt % to 50 wt %, or 10 wt % to 50 wt %, or 20 wt % to 50 wt %, or 0.5 wt % to 40 wt %, or 0.5 wt % to 30 wt %, or 0.5 wt % to 25 wt %, or 0.5 wt % to 20 wt %, or 0.5 wt % to 15 wt %, or 0.5 wt % to 10 wt %, or 0.5 wt % to 5 wt %, or 0.5 wt % to 4 wt %, or 0.5 wt % to 3 wt %, or 0.5 wt % to 2 wt %, or 0.5 wt % to 1 wt %, 5 wt %, or 0.5 wt % to 1 wt %, or 1 wt % to 2 wt %, or 2 wt % to 3 wt %, or 3 wt % to 4 wt %, or 4 wt % to 5 wt %, or 5 wt % to 6 wt %, or 6 wt % to 7 wt %, or 7 wt % to 8 wt %, or 8 wt % to 9 wt %, or 9 wt % to 10 wt %, or 10 wt % to 15 wt %, or 15 wt % to 20 wt %, or 20 wt % to 25 wt %, or 25 wt % to 30 wt %, or 30 wt % to 35 wt %, or 35 wt % to 40 wt %, or 40 wt % to 45 wt %, or 45 wt % to 50 wt % lower than the TOC of the mineral product obtained from the same mineral ore process stream using the same processing method, but without adding a cationic copolymer in accordance with first embodiments. In some second embodiments the comparative TOC of a mineral product is determined by comparing the TOC of a mineral ore process stream before addition of a cationic copolymer in accordance with first embodiments, with the TOC of the treated mineral process stream after adding the cationic copolymer, then carrying out one or more mineral ore processing steps. In other second embodiments the comparative TOC of a mineral product is suitably determined by comparing the TOC of a mineral product after carrying out one or more mineral ore processing steps to collect a mineral product therefrom without addition of a cationic copolymer in accordance with first embodiments, with the TOC of the mineral product obtained from a treated mineral process stream after carrying out the same processing steps to collect a mineral product therefrom. The one or more mineral ore processing steps include one or more reaction, extraction, flotation, filtration, sedimentation or other gravity-based separation, skimming, flocculation, coagulation, dewatering, drying, or other process steps conventionally carried out to process a mineral ore to collect a mineral product therefrom.

In any one or more second embodiments herein, after processing a treated mineral ore process stream to collect a mineral product therefrom, the total organic content (TOC) of the mineral product collected is at least 0.1% lower by weight and as much as 50% lower by weight than the TOC of the mineral product obtained from the same mineral ore using the same mineral ore process stream, except including a DADMAC homopolymer in the mineral ore process stream instead of a cationic copolymer of first embodiments, for example 0.1 wt % to 50 wt %, or 0.5 wt % to 50 wt %, or 1 wt % to 50 wt %, or 2 wt % to 50 wt %, or 3 wt % to 50 wt %, or 4 wt % to 50 wt %, or 5 wt % to 50 wt %, or 10 wt % to 50 wt %, or 20 wt % to 50 wt %, or 0.1 wt % to 40 wt %, or 0.1 wt % to 30 wt %, or 0.1 wt % to 25 wt %, or 0.1 wt % to 20 wt %, or 0.1 wt % to 15 wt %, or 0.1 wt % to 10 wt %, or 0.1 wt % to 5 wt %, or 0.1 wt % to 4 wt %, or 0.1 wt % to 3 wt %, or 0.1 wt % to 2 wt %, or 0.1 wt % to 1 wt %, or 0.1 wt % to 1 wt %, or 1 wt % to 2 wt %, or 2 wt % to 3 wt %, or 3 wt % to 4 wt %, or 4 wt % to 5 wt %, or 5 wt % to 6 wt %, or 6 wt % to 7 wt %, or 7 wt % to 8 wt %, or 8 wt % to 9 wt %, or 9 wt % to 10 wt %, or 10 wt % to 15 wt %, or 15 wt % to 20 wt %, or 20 wt % to 25 wt %, or 25 wt % to 30 wt %, or 30 wt % to 35 wt %, or 35 wt % to 40 wt %, or 40 wt % to 45 wt %, or 45 wt % to 50 wt % lower than the TOC of the mineral product obtained from the same mineral ore using the same mineral ore process stream, except including a DADMAC homopolymer in the mineral ore process stream instead of a cationic copolymer of first embodiments. In some such embodiments, the comparative TOC of a mineral product is suitably determined by comparing the TOC of a mineral product obtained by adding a DADMAC homopolymer to a mineral ore process stream, then carrying out one or more mineral ore processing steps to collect a mineral product therefrom; with the TOC of the mineral product obtained from a treated mineral process stream after carrying out the same processing steps to collect a mineral product therefrom. The one or more mineral ore processing steps can include one or more reaction, extraction, flotation, filtration, sedimentation, flocculation, coagulation, or other process steps conventionally carried out to process the mineral ore to collect a mineral product therefrom.

A number of methods are available to assist the skilled artisan in determining yield benefit by precipitation of a mineral in a mineral ore slurry. Such “precipitation tests” are commonly used by operators to determine a range of issues within a mineral processing circuit and details of the methods used are well documented in the literature. Bayer products are addressed in Watts and Utley, “Volumetric Analysis of Sodium Aluminate Solutions”, Anal. Chem. 1953, 25, 6, 864-867. Other sources of mineral yield determination are suitably employed in conjunction with any one or more methods of second embodiments herein.

In any one or more embodiments herein, after processing a treated mineral ore process stream to collect a mineral product therefrom, the yield of the mineral product obtained is at least 0.1% by weight greater and as much as 50% by weight greater than the yield of the mineral product obtained from the same mineral ore process stream using the same processing method, but without adding a cationic copolymer in accordance with first embodiments; for example, in embodiments, the yield is 0.1 wt % to 50 wt %, or 0.5 wt % to 50 wt %, or 1 wt % to 50 wt %, or 2 wt % to 50 wt %, or 3 wt % to 50 wt %, or 4 wt % to 50 wt %, or 5 wt % to 50 wt %, or 10 wt % to 50 wt %, or 20 wt % to 50 wt %, or 0.1 wt % to 40 wt %, or 0.1 wt % to 30 wt %, or 0.1 wt % to 25 wt %, or 0.1 wt % to 20 wt %, or 0.1 wt % to 15 wt %, or 0.1 wt % to 10 wt %, or 0.1 wt % to 5 wt %, or 0.1 wt % to 4 wt %, or 0.1 wt % to 3 wt %, or 0.1 wt % to 2 wt %, or 0.1 wt % to 1 wt %, or 0.1 wt % to 1 wt %, or 1 wt % to 2 wt %, or 2 wt % to 3 wt %, or 3 wt % to 4 wt %, or 4 wt % to 5 wt %, or 5 wt % to 6 wt %, or 6 wt % to 7 wt %, or 7 wt % to 8 wt %, or 8 wt % to 9 wt %, or 9 wt % to 10 wt %, or 10 wt % to 15 wt %, or 15 wt % to 20 wt %, or 20 wt % to 25 wt %, or 25 wt % to 30 wt %, or 30 wt % to 35 wt %, or 35 wt % to 40 wt %, or 40 wt % to 45 wt %, or 45 wt % to 50 wt % greater than the yield of the mineral product obtained from the same mineral ore process stream using the same processing method, but without adding a cationic copolymer in accordance with first embodiments. In some such embodiments the yield of a mineral product is suitably determined by comparing the yield of a mineral product after carrying out one or more mineral ore processing steps to collect a mineral product therefrom without addition of a cationic copolymer in accordance with first embodiments, with the yield of the mineral product obtained from a treated mineral process stream after carrying out the same processing steps to collect a mineral product therefrom. The one or more mineral ore processing steps include one or more reaction, extraction, flotation, filtration, sedimentation or other gravity-based separation, skimming, flocculation, coagulation, dewatering, drying, or other process steps conventionally carried out to process a mineral ore to collect a mineral product therefrom.

In any one or more embodiments herein, the yield of a mineral product obtained in accordance with any one or more of the foregoing treated mineral ore compositions is at least 0.1% by weight greater and as much as 50% by weight greater than the yield of the mineral product obtained from the same mineral ore using the same mineral ore process stream, except including a DADMAC homopolymer in the mineral ore process stream instead of a cationic copolymer of first embodiments; for example, in one or more embodiments herein, the yield is 0.1 wt % to 50 wt %, or 0.5 wt % to 50 wt %, or 1 wt % to 50 wt %, or 2 wt % to 50 wt %, or 3 wt % to 50 wt %, or 4 wt % to 50 wt %, or 5 wt % to 50 wt %, or 10 wt % to 50 wt %, or 20 wt % to 50 wt %, or 0.1 wt % to 40 wt %, or 0.1 wt % to 30 wt %, or 0.1 wt % to 25 wt %, or 0.1 wt % to 20 wt %, or 0.1 wt % to 15 wt %, or 0.1 wt % to 10 wt %, or 0.1 wt % to 5 wt %, or 0.1 wt % to 4 wt %, or 0.1 wt % to 3 wt %, or 0.1 wt % to 2 wt %, or 0.1 wt % to 1 wt %, or 0.1 wt % to 1 wt %, or 1 wt % to 2 wt %, or 2 wt % to 3 wt %, or 3 wt % to 4 wt %, or 4 wt % to 5 wt %, or 5 wt % to 6 wt %, or 6 wt % to 7 wt %, or 7 wt % to 8 wt %, or 8 wt % to 9 wt %, or 9 wt % to 10 wt %, or 10 wt % to 15 wt %, or 15 wt % to 20 wt %, or 20 wt % to 25 wt %, or 25 wt % to 30 wt %, or 30 wt % to 35 wt %, or 35 wt % to 40 wt %, or 40 wt % to 45 wt %, or 45 wt % to 50 wt % greater than the yield of the mineral product obtained from the same mineral ore using the same mineral ore process stream, except including a DADMAC homopolymer in the mineral ore process stream instead of a cationic copolymer of first embodiments. In some such embodiments, the comparative yield of a mineral product is suitably determined by comparing the yield of a mineral product obtained by adding a DADMAC homopolymer to a mineral ore process stream, then carrying out one or more mineral ore processing steps to collect a mineral product therefrom; with the yield of the mineral product obtained from a treated mineral process stream after carrying out the same processing steps to collect a mineral product therefrom. The one or more mineral ore processing steps can include one or more reaction, extraction, flotation, filtration, sedimentation, flocculation, coagulation, or other process steps conventionally carried out to process the mineral ore to collect a mineral product therefrom.

In any one or more second embodiments herein, a cationic copolymer is added at two or more different points to a mineral ore, a process stream, or a mineral ore process stream, prior to collecting a mineral product therefrom. Thus, for example, a first amount of a cationic copolymer is suitably added to a mineral ore to form a treated mineral ore; the treated mineral ore is mixed with a process stream to form a treated mineral ore process stream; and a second amount of the cationic copolymer is added to the treated mineral ore process stream to provide a suitable concentration of the cationic copolymer in the treated mineral ore process stream to obtain optimal yield, TOC, or both yield and TOC in the resulting mineral product collected. In another example, a first amount of a cationic copolymer is added to a process stream to form a treated process stream, a second amount of the cationic copolymer is added to a mineral ore to form a treated mineral ore, and the treated process stream is combined with the treated mineral ore to form a treated mineral ore process stream having a suitable concentration of the cationic copolymer to obtain optimal yield, TOC, or both yield and TOC in the resulting mineral product collected.

In any one or more second embodiments herein, two or more different cationic copolymers are added to a mineral ore, to a process stream, or a mineral ore process stream, wherein the two or more cationic copolymers differ by chemical structure, molecular weight, or both chemical structure and molecular weight. In some such embodiments, the two or more different cationic copolymer are added at two or more different points in a single mineral ore process, prior to collecting a mineral product therefrom. In embodiments, one, two, or more cationic copolymers are added to a mineral ore, to a treated mineral ore, to a process stream, to a treated process stream, to a mineral ore process stream, or to a treated mineral ore process stream at two or more different points in a single mineral ore process, in order to achieve different results by each addition. In a first example, a first addition of a first cationic copolymer to a mineral ore during comminuting lowers TOC in the collected mineral product, while a second addition of the first cationic copolymer to the treated mineral ore process stream further lowers TOC in the mineral product beyond the amount obtained by the first addition alone. In a second example, a first addition of a first cationic copolymer to a mineral ore during comminuting to form a treated mineral ore, lowers TOC in the collected mineral product; while a second addition of a second cationic copolymer to the process stream prior to the addition of the treated mineral ore thereto, increases the yield of collected mineral product, further wherein the second cationic copolymer has a different chemical structure from the first polymer. In some embodiments of the second example, the first cationic copolymer is a cationic copolymer of first embodiments having repeat units I and II, while the second cationic copolymer is a cationic copolymer of first embodiments having repeat units I and III; in other embodiments of the second example, the first cationic copolymer is a cationic copolymer of first embodiments having repeat units I and IV, while the second cationic copolymer is a cationic copolymer of first embodiments having repeat units I and II; in still other embodiments of the second example, the first cationic copolymer is a cationic copolymer of first embodiments having repeat units I and III, while the second cationic copolymer is a cationic copolymer of first embodiments having repeat units I and II; other embodiments are easily envisioned and implemented to add one, two, three, or more different cationic copolymers of first embodiments at one, two, three, or more points in a single mineral ore process; whereby the one or more additions of the one or more cationic copolymers results in reduced TOC, increased yield, or both in accordance with the above disclosures.

One representative example of a mineral ore process is the Bayer process. In the Bayer process, comminution of bauxite is typically followed by a digestion stage, wherein alumina is extracted by digesting the bauxite in a solution of sodium hydroxide solution (“caustic” or “caustic solution”) forming an aqueous sodium aluminate solution; a clarification stage, wherein a solid phase residue (“red mud” or “bauxite residue) is separated from a supersaturated aluminate solution (“pregnant liquor”) via sedimentation and filtering; a precipitation stage, wherein aluminum trihydrate is precipitated from the sodium aluminate solution (“liquor” or “Bayer Process liquor”) and grown in the form of aluminum trihydrate crystals (crystallization); a classification stage, wherein the crystals are separated from the mixture; and finally a clarification stage, wherein the aluminum trihydrate decomposes to aluminum oxide that is collected as the principal end mineral product. More detailed descriptions of the Bayer process and its steps are readily available, and further are well known to those of skill.

In some second embodiments herein, one or more cationic copolymers are added at one or more points in a Bayer process to obtain improved removal of NOCs and/or improved yield of alumina trihydrate product. For example, in some second embodiments herein, one or more cationic copolymers are added upstream of a precipitation stage of the Bayer process. In some second embodiments, one or more cationic copolymers are added upstream of a clarification stage of the Bayer process. In some second embodiments one or more cationic copolymers are added upstream of a digestion stage of the Bayer process. In some second embodiments, one or more cationic copolymers are added to a bauxite ore to form a treated bauxite ore, and water is added to the treated bauxite ore to form a treated bauxite processing stream, which is then subjected to all stages of the Bayer process; in some such embodiments, caustic is also added to the process stream or to the treated bauxite process stream to form a treated Bayer product in the digestion stage. In some second embodiments, one or more cationic copolymers are added at two or more stages of the Bayer process. In some second embodiments, two or more cationic copolymers are added at one or more stages of the Bayer process.

Another example of a mineral ore process benefitting from one or more additions of one or more cationic copolymers is treatment of a lithium ore process stream. In embodiments, a lithium ore is comminuted and applied to a froth flotation, which results in separation of the lithium ore into two lithium ore process streams: an overflow and an underflow. In such embodiments, the underflow, the overflow, or both the underflow and the overflow may be further purified, for example by one or more solid-liquid separation steps to remove NOC, NOC reaction products, and other impurities. Addition of one or more cationic copolymers to an underflow, an overflow, or both an underflow and an overflow, at one or more points in a single lithium ore process obtains improved results in removal of NOC during one or more solid-liquid separations therein.

In some second embodiments, a cationic copolymer is water soluble or water dispersible, and is dissolved or dispersed in water for adding to a mineral ore, a process stream, and/or a mineral ore process stream. In some second embodiments, a cationic copolymer is soluble or dispersible in an aqueous mixture, that is, a mixture of water with a water-soluble cosolvent; and is dissolved or dispersed in a water/cosolvent mixture for adding to a mineral ore, a process stream, and/or a mineral ore process stream. In some second embodiments, one or more cationic copolymers are added to a mineral ore or a mineral ore process stream neat (100% actives or 100% solids). In other second embodiments, one or more cationic copolymers are or dissolved or dispersed in an aqueous mixture having 0.001 wt % to 80 wt % of one or more cationic copolymers dissolved or dispersed therein, for example 0.01 wt % to 50 wt % or even 1 wt % to 30 wt % of one or more cationic copolymers dissolved therein, for addition to a mineral ore or a mineral ore process stream.

### EXPERIMENTAL PROCEDURE

### General

Some of the Examples below employ a Bayer green liquor from an industrial bauxite ore process stream. The Bayer green liquor is obtained by digesting bauxite ore in a hot caustic aqueous environment, followed by subsidence filtration. Subsidence filtration does not achieve complete separation of dissolved aluminum compounds from other compounds, such as NOC, that are suspended, dissolved, or dispersed therein, resulting in measurable total organic carbon (TOC) content that varies between ore sources. Accordingly, without further treatment to separate them, the NOC will directly enter the aluminum hydroxide purification process, where they result in increased chemical impurities measured in the final aluminum trihydrate product. See Shuai, S., Er-wei, S., and Guo-bao, W., The Effects of Suspended Solids in Green Liquor on the Quality of Product During the Precipitation Process, TRAVAUX 49, Proceedings of the 38^{th} International ICSOBA onference, 16-18 Nov. 2020, pp. 175-180, 175.

The following General Procedure is employed in the Examples below where indicated. All tests carried out using the General Procedure are conducted in duplicate.

### General Procedure.

Individual bottles are charged with 500 mL of a Bayer process green liquor (500 mL) and either 3000 ppm actives of a selected polymer in a 20 wt % or 30 wt % aqueous solution, or an equivalent weight of water if no polymer is added. The bottles are capped firmly after filling, then placed in a rotating water bath at room temperature to mix. After 30 minutes of mixing, the bottles are removed from the rotating water bath, and the contents filtered through filter paper to provide a filtrate.

Absorbance measurement. A sample of the filtrate is removed and passed through a 0.45 μm syringe filter; and the syringe-filtered sample is tested for light absorbance at 691 nm wavelength using a UV-Visible spectrophotometer. Then the syringe-filtered sample is diluted twenty-fold with deionized water, and re-measured with the same spectrophotometer at 461 nm wavelength. The absorbance of the sample is used to indicate the relative concentration of organic impurities that impart color to the alumina trihydrate product.

Measurement of precipitation yield: 210 g of the filtrate is split into two 250 mL bottles: Bottle A, containing 80 g filtrate, and Bottle B, containing 130 g filtrate. Bottle A is placed in a rotating water bath set to a temperature of 81° C. and allowed to equilibrate. Then 80 g of coarse alumina seed particles obtained from an alumina processing facility are added to Bottle A, and Bottle A is placed back into the rotating water bath at 81° C. (Bottle B is not removed from the water bath in this step). After 2.5 hours of rotating in the heated water bath, the contents of Bottle B are added to the contents of Bottle A. Following the addition, Bottle A is returned to the rotating water bath, and the temperature of the bath is reduced to 72° C. at a rate of 20 minutes per degree; then reduced from 72° C. to 62° C. at a rate of 80° C. per minute. When the temperature of the rotating bath reaches 62° C., Bottle A is removed from the bath, and 10 mL sodium gluconate (400 g/L) is added to Bottle A. Then the contents of Bottle A are vacuum filtered through a pre-weighed filter paper. The solids collected on the filter paper are washed with hot deionized water, and the washed solids are dried. The dried solids are collected and weighed to determine the precipitation yield of alumina trihydrate from the Bayer process green liquor, in grams alumina trihydrate per liter of green liquor.

### Example 1

Polymers having repeat unit content shown in Table 1 were synthesized in or purchased as 20 wt % or 30 wt % actives (solids) in water. Polymer CC-6 includes repeat unit II, and has a polyDADMAC/Epi-DMA ratio of 23/77 by weight and a viscosity of 220 cps measured by Brookfield viscometer.

Polymer CC-7 includes repeat unit II, and has a polyDADMAC/Epi-DMA ratio of 25/75 by weight and a viscosity of 42 cps measured by Brookfield viscometer.

TABLE 1
Repeat unit content of cationic copolymers CC-1 to CC-7.

| | | Repeat | Repeat | Repeat | | |
|---|---|---|---|---|---|---|
| | Repeat | unit | unit | unit | Acrylic | |
| | unit I, | II, | IIIa, | IVa, | acid, | Acrylamide, |
| Polymer | wt % | wt % | wt % | wt % | wt % | wt % |
| CC-1 | 90 | | | 10 | | |
| CC-2 | 80 | | 5 | 5 | 5 | 5 |
| CC-3 | 60 | | 35 | | 5 | |
| CC-4 | 85 | | | 10 | 5 | |
| CC-5 | 50 | | 50 | | | |
| CC-6 | 23 | 77 | | | | |
| CC-7 | 25 | 75 | | | | |

Repeat unit structures I, II, IIIa, and IVa are shown above.

The synthetic polymers in Table 1 were prepared by radical polymerization at 70-100 C in water, using ammonium persulfate as initiator, except for CC-6 and CC-7, which were obtained forming a copolymer of DADMAC and diallylamine, followed by reacting epichlorohydrin and dimethylamine with the DADMAC/diallylamine copolymer.

Additionally, two homopolymers were obtained: “Control 1”, a DADMAC homopolymer, was synthesized by radical polymerization in water as described above; and “Control 2”, an epichlorohydrin-dimethylamine polymer, was synthesized using conventional condensation methods. Control 2 consists solely of Epi-DMA repeat units; it is not part of a repeat unit II above, but a control polymer for comparative testing of copolymers including repeat unit II.

### Example 2

Bayer process green liquor was treated according to the General Procedure above, adding 3000 ppm of polymer CC-3 and comparing absorbance and alumina trihydrate yield to the same treatment carried out with no polymer (blank) and also carried out with 3000 ppm DADMAC homopolymer (Control 1). Absorbance measurements and precipitation yield measurements obtained are shown in Table 2.

TABLE 2
Absorbance measurements and precipitation yield
of alumina trihydrate for Bayer process green
liquors treated in accordance with Example 2.

| | Absorbance | Absorbance | Trihydrate |
|---|---|---|---|
| Polymer added | at 691 nm | at 461 nm | Yield, g/L |
| None (blank) | 1.177 | 1.35 | 96.925 |
| Control-1 | 0.414 | 0.808 | 97.100 |
| CC-3 | 1.089 | 1.244 | 97.325 |

As can be seen in Table 2, Bayer green liquor treated with cationic copolymer CC-3 obtains some reduction in colored organic compounds, and excellent yield of alumina trihydrate compared to the blank (untreated Bayer green liquor), and a higher precipitation yield than the Control 1 polymer: copolymer CC-3 removes yield-inhibiting species from the Bayer green liquor to produce an increase in yield of 0.4 g/L over the blank, while adding the Control 1 polymer only increases yield by 0.175 g/L over the blank.

### Example 3

Bayer process green liquor was treated according to the General Procedure above, adding 3000 ppm of polymer CC-4 and comparing absorbance and alumina trihydrate yield to the same treatment carried out with no polymer (blank) and also carried out with 3000 ppm Control 1. Absorbance measurements and precipitation yield measurements obtained are shown in Table 3.

TABLE 3
Absorbance measurements and precipitation yield
of alumina trihydrate for Bayer process green
liquors treated in accordance with Example 3.

| | Absorbance at | Absorbance at | Trihydrate |
|---|---|---|---|
| Polymer added | 691 nm | 461 nm | Yield, g/L |
| None (blank) | 1.116 | 1.297 | 93.075 |
| Control 1 | 0.372 | 0.752 | 93.125 |
| CC-4 | 0.382 | 0.804 | 93.150 |

As can be seen in Table 3, Bayer green liquor treated with cationic copolymer CC-4 obtains good reduction in colored organic compounds, and excellent precipitation yield of alumina trihydrate compared to the blank (untreated Bayer green liquor), and higher precipitation yield than Bayer green liquor treated with DADMAC homopolymer (Control 1): CC-4 removes yield-inhibiting species from the Bayer green liquor to produce an increase in yield of 0.075 g/L over the blank, while adding the Control 1 polymer only increases yield by 0.050 g/L over the blank.

### Example 4

First treatment and measurement cycle: A bottle is charged with 700 mL of a Bayer process green liquor and a 3000 ppm dose of a polymer. The bottle is capped firmly and placed in a rotating water bath at room temperature (not heated). After 30 minutes of rotating, the bottle is removed from the rotating water bath, and the contents of the bottle are filtered through filter paper to provide a filtrate. A syringe-filtered sample of the filtrate is removed and subjected to UV-visible spectrophotometry as described above in “Absorbance Measurement”. A second syringe-filtered sample of the filtrate is removed and analyzed for Total Organic Carbon (TOC) content using differential combustion and IR measurement of the liquor with and without phosphoric acid treatment to purge inorganic carbon (Total Inorganic Carbon, or TIC) from the total carbon measured for the sample.

The foregoing steps represent one treatment and measurement cycle. The filtrate obtained in the first treatment and measurement cycle is a first filtrate, obtained by the first addition of the polymer to the Bayer green liquor.

Then a second treatment and measurement cycle is carried out, wherein a second 3000 ppm dose of the polymer is added to the first filtrate for a cumulative dosage of 6000 ppm polymer added; then the mixing, filtering, and measuring as in the first treatment and measurement cycle is repeated in the second cycle to obtain a second filtrate. In this manner, a total of five treatment and measurement cycles were carried out using cationic copolymer CC-1, and adding an additional 3000 ppm of CC-1 to the filtrate obtained in the previous cycle, until a cumulative dosage of 15,000 ppm CC-1 was obtained after the five cycles. Absorbance measurements and TOC after each of the five cycles are shown in Table 4.

The foregoing five treatment and measurement cycles were repeated using the Control 1 polymer to obtain a cumulative dosage of 15,000 ppm Control 1 after the five cycles. Additionally, one cycle was carried out on the Bayer green liquor in the absence of any polymer, to obtain the 0 ppm values of absorbance and TOC. Absorbance measurements and TOC after each of the five cycles are shown in Table 4.

TABLE 4
Absorbance measurements and TOC of filtrates obtained
over five cycles from a Bayer process green liquor
treated in accordance with Example 4.

| | | Cumulative | | | |
|---|---|---|---|---|---|
| | Cycle | polymer dose | Absorbance, | Absorbance, | TOC, |
| Polymer | No. | (ppm) | 691 nm | 461 nm | g/L |
| CC-1 | 0 | 0 | 1.283 | 1.398 | 23.72 |
| | 1 | 3000 | 0.794 | 1.025 | 23.63 |
| | 2 | 6000 | 0.486 | 0.808 | 21.2 |
| | 3 | 9000 | 0.301 | 0.634 | 19.8 |
| | 4 | 12000 | 0.18 | 0.512 | 18.87 |
| | 5 | 15000 | 0.138 | 0.429 | 18.28 |
| Control 1 | 0 | 0 | 1.283 | 1.398 | 23.72 |
| | 1 | 3000 | 0.576 | 0.931 | 22.82 |
| | 2 | 6000 | 0.326 | 0.697 | 21.59 |
| | 3 | 9000 | 0.212 | 0.538 | 21.49 |
| | 4 | 12000 | 0.226 | 0.443 | 19.72 |
| | 5 | 15000 | 0.124 | 0.392 | 19.7 |

The results displayed in Table 4 show that when a hydrophobic functional group is included in the cationic copolymer polymer structure, more total organic content is removed from the Bayer green liquor over multiple cycles, which is commensurate with a continuous, multistage treatment conventionally obtained in an industrial setting. This demonstrates that more yield-deleterious organic compounds are removed by cationic copolymers having hydrophobic functionality, as imparted by repeat unit IVa present in cationic copolymer CC-1, than are removed by the same weight of DADMAC homopolymer.

### Example 5

Bayer process green liquor was treated using the procedure of Example 4, except the 3000 ppm dosages were applied to the indicated volume of Bayer process green liquor over four treatment and measurement cycles, to obtain a cumulative dosage of 12,000 ppm for Control 1, as shown in Table 5. Finally, the four cycles were carried out on the Bayer process green liquor without adding any polymer, and instead adding water in each cycle in the same weight as the amount of CC-5 solution added in that cycle; that is, a “blank” or untreated Bayer process green liquor; this is also shown in Table 5. Absorbance measurements and TOC after each of the four cycles are shown in Table 6.

TABLE 5
The four cycles of Bayer process green liquor
treatment in accordance with Example 5.

| | | Bayer Green | | |
|---|---|---|---|---|
| | | Liquor | Cumulative | Water |
| Polymer | Cycle No. | Volume, mL | Polymer Dose, ppm | Dose, mL |
| None | 1 | 800 | — | 13.6 |
| (blank) | 2 | 700 | — | 11.9 |
| | 3 | 600 | — | 10.2 |
| | 4 | 500 | — | 8.5 |
| Control 1 | 1 | 800 | 3000 | — |
| | 2 | 700 | 6000 | — |
| | 3 | 600 | 9000 | — |
| | 4 | 500 | 12000 | — |
| CC-3 | 1 | 800 | 3000 | — |
| | 2 | 700 | 6000 | — |
| | 3 | 600 | 9000 | — |
| | 4 | 500 | 12000 | — |

After completing the four cycles, the fourth filtrate was subjected to the absorbance measurement and precipitation yield methods outlined in the General Procedure above. Absorbance at 691 nm and yield are reported in Table 6.

TABLE 6
Absorbance at 691 nm of a filtrate obtained after four cycles
of treatment in accordance with Example 5; and alumina trihydrate
yield obtained from the filtrate after the four cycles.

| | Absorbance | Trihydrate |
|---|---|---|
| Polymer | (691 nm) | Yield g/L |
| None (blank) | 1.115 | 84.5 |
| Control 1 | 0.143 | 84.4 |
| CC-3 | 0.464 | 85.25 |

The results in Table 6 clearly demonstrate that Control 1, DADMAC homopolymer, is effective at removing colored organic species, but obtains effectively no improvement in yield over the blank when considering the error of the test. In sharp contrast, the cationic copolymer CC-3 obtains a 0.75 g/L yield improvement over the blank and 0.85 g/L yield improvement over the same weight of DADMAC homopolymer.

### Example 6

The procedure of Example 5 was repeated, except that only two cycles were carried out instead of four, for a cumulative dosage of 6000 ppm, further in accordance with the polymer additions shown in Table 7. Absorbance measurements were obtained in each cycle sand precipitation yield measurements obtained are shown in Table 8.

TABLE 7
The two cycles of Bayer process green liquor
treatment in accordance with Example 6.

| | |
|---|---|
| Cycle 1 | Cycle 2 |

| | Polymer | Dose | Polymer | Dose |
|---|---|---|---|---|
| | Dose | Water | Dose | Water |
| Polymer | (ppm) | (mL) | (ppm) | (mL) |
| None (blank) | — | 4.9 | | 4.2 |
| Control 1 | 3000 | — | 3000 | — |
| CC-3 | 3000 | — | 3000 | — |
| CC-5 | 3000 | — | 3000 | — |

TABLE 8
Absorbance at 691 nm and at 461 nm of a filtrate obtained after first
and second cycles of treatment in accordance with Example 6; and alumina
trihydrate yield obtained from the filtrate after the two cycles.

| | Absorbance | Absorbance | Absorbance | Absorbance | |
|---|---|---|---|---|---|
| | 1st | 2nd | 1st | 2nd | |
| | Extraction | Extraction | Extraction | Extraction | Trihydrate |
| Polymer | 691 nm | 691 nm | 461 nm | 461 nm | Yield, g/L |
| None (blank) | 1.302 | 1.276 | 1.459 | 1.483 | 77.075 |
| Control 1 | 0.429 | 0.267 | 0.898 | 0.677 | 77.3 |
| CC-5 | 1.197 | 0.946 | 1.387 | 1.197 | 77.825 |

As can be observed in yield results displayed in Table 8, the yield benefit of polymer CC-5 over the polyDADMAC (Control 1) treated liquor is significant, even though polyDADMAC obtains a greater reduction in the concentration of colored species. The high yield is attributed to the dihydroxy functional group incorporated into the polymer CC-5.

### Example 7

The procedure of Example 6 was repeated in accordance with the polymer additions shown in Table 9. Absorbance measurements at 691 nm obtained in each cycle, and precipitation yield are shown in Table 10.

TABLE 9
The two cycles of Bayer process green liquor
treatment in accordance with Example 7.

| | Extraction Step 1 | | Extraction Step 2 | |
|---|---|---|---|---|
| | Polymer | | Polymer | |
| | Dose | | Dose | |
| Polymer | (ppm) | Water (ml) | (ppm) | Water (mL) |
| None (blank) | 0 | 7.2 | 0 | 6.0 |
| Control 1 | 3000 | | 3000 | |
| Control 2 | 3000 | | 3000 | |
| CC-6 | 3000 | | 3000 | |
| CC-7 | 3000 | | 3000 | |

TABLE 10
Absorbance at 691 nm of a filtrate obtained after first and second
cycles of treatment in accordance with Example 7; and alumina trihydrate
yield obtained from the filtrate after the two cycles.

| | Absorbance 1st | Absorbance 2nd | |
|---|---|---|---|
| | Extraction | Extraction | Trihydrate Yield |
| Polymer | 691 nm | 691 nm | g/L |
| None (blank) | 1.109 | 1.099 | 117.06 |
| Control 1 | 0.456 | 0.237 | 117.04 |
| Control 2 | 0.597 | 0.813 | 118.00 |
| CC-6 | 1.009 | 0.935 | 118.26 |
| CC-7 | 0.901 | 0.770 | 117.56 |

### Example 8

Aliquots of a spodumene ore slimes tailings (2% solids concentration) obtained from a spodumene flotation circuit were placed in 250 mL graduated cylinders. The slimes tailings include particulate gangue waste from spodumene beneficiation; the particulate often has an average particle size of 20 microns or less.

The polymers listed in Table 11 were added to water to form 1 wt % solutions, and the solutions were added to the surface of the tailings in the cylinders at the amount indicated in Table 11. The polymers Control 1 (polyDADMAC), CC-3, and CC-6 are discussed above. Control 3 is an epichlorohydrin-dimethylamine polymer. The cylinders were stoppered and inverted 10 times to mix the contents. Then the cylinders were placed on a bench and left undisturbed, and a timer was started. The cylinders were observed as settling solids collected in the cylinder. The settled solids height was recorded at the 3 minute mark. The clarity of the supernatant was measured using a turbidity wedge at 3 minutes. Results of settled solids height and turbidity for each of the tested polymers is shown in Table 11.

TABLE 11
Height of settled solids and turbidity measurements obtained
after 3 minutes in the test procedure of Example 8.

| | Polymer | | Turbidity Wedge | |
|---|---|---|---|---|
| | Dose | Settling rate | Number of | Settled solids |
| Polymer | (ppm) | (m/hr) | Supernatant | height (ml) |
| Control 1 | 64 | 5.7 | 7 | 84 |
| | 128 | 16.2 | 46+ | 58 |
| | 192 | 9.3 | 46+ | 76 |
| | 256 | 6.5 | 46+ | 84 |
| Control 3 | 220 | 6.1 | 15 | 87 |
| | 440 | 6.1 | 46+ | 92 |
| | 660 | 5.9 | 44 | 92 |
| | 880 | 6.4 | 32 | 90 |
| CC-3 | 120 | 8.1 | 25 | 50 |
| | 240 | 7.4 | 46+ | 76 |
| | 360 | 9.7 | 46+ | 60 |
| | 480 | 5.9 | 46+ | 105 |
| CC-6 | 80 | No Interface | 0 | 10 |
| | 160 | No Interface | 0 | 40 |
| | 240 | 5.9 | 4 | 74 |
| | 320 | 9.72 | 46+ | 68 |

What is claimed:

1. A method of treating a mineral ore process stream, the method comprising adding a cationic copolymer to the mineral ore process stream to form a treated mineral ore process stream, wherein the cationic copolymer comprises one or more repeat units having structure I and one or more repeat units selected from structure II, structure III, structure IV, or any combination thereof: 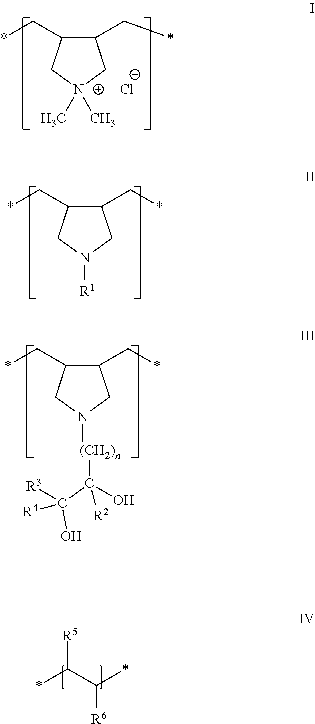
wherein n is an integer between 1 and 6, R¹ is a polymeric moiety comprising one or more repeat units having structure V, 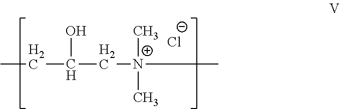
R², R³, and R⁴ are independently selected from hydrogen, C1-C10 alkyl moieties, and C2-C30 hydroxyalkyl moieties; R⁵ is hydrogen or methyl; and R⁶ is selected from C6-C30 hydrocarbyl, C8-C30 alkaryl or aralkyl, ethylene oxide, propylene oxide, or a combination of two or more thereof; and
optionally one or more additional repeat units derived from acrylic acid or a conjugate base thereof, methacrylic acid or a conjugate base thereof, acrylamide, methacrylamide, methylolacrylamide, styrene, allylamine, diallylamine, triallylamine, maleic acid or a conjugate base thereof, or itaconic acid or a conjugate base thereof.

2. The method of claim 1 wherein the mineral ore is a bauxite ore or a spodumene ore.

3. The method of claim 1 wherein the mineral ore process stream comprises one or more of: aluminum oxide, sodium aluminate, or alumina.

4. The method of claim 1 wherein 0.01% to 1% by weight of the copolymer is added to the mineral ore process stream.

5. The method of claim 1 wherein the copolymer further comprises one or more additional repeat units, wherein one or more of the one or more additional repeat units are derived from acrylic acid or a conjugate base thereof, methacrylic acid or a conjugate base thereof, acrylamide, methacrylamide, methylolacrylamide, styrene, allylamine, diallylamine, triallylamine, maleic acid or a conjugate base thereof, or itaconic acid or a conjugate base thereof.

6. A composition comprising
a mineral ore, and
a copolymer comprising one or more repeat units having the structure of formula I, and one or more repeat units having a structure selected from formulae II, III, IV, or any combination thereof: 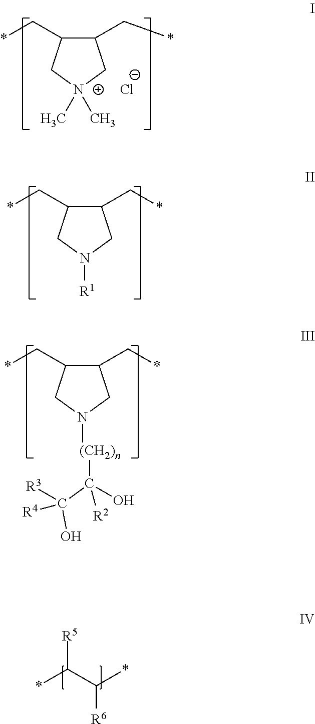
wherein n is an integer between 1 and 6, R¹ is a polymeric moiety comprising one or more repeat units having the structure of formula V 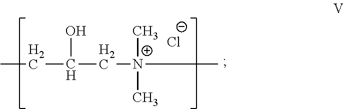
R², R³, and R⁴ are independently selected from hydrogen, C1-C10 alkyl moieties, and C2-C30 hydroxyalkyl moieties; R⁵ is hydrogen or methyl; and R⁶ is selected from C6-C30 hydrocarbyl, C8-C30 alkaryl or aralkyl, ethylene oxide, propylene oxide, or a combination of two or more thereof; and
optionally one or more additional repeat units derived from acrylic acid or a conjugate base thereof, methacrylic acid or a conjugate base thereof, acrylamide, methacrylamide, methylolacrylamide, styrene, allylamine, diallylamine, triallylamine, maleic acid or a conjugate base thereof, or itaconic acid or a conjugate base thereof.

7. The composition of claim 6 wherein one or both of R³ and R⁴ are C3-C10 hydroxyalkyl moieties comprising 2 to 6 hydroxyl groups.

8. The composition of claim 6 wherein n is 1 and R², R³, and R⁴ are each hydrogen.

9. The composition of claim 6 wherein one or more repeat units having the structure of formula IV have the structure IVa, 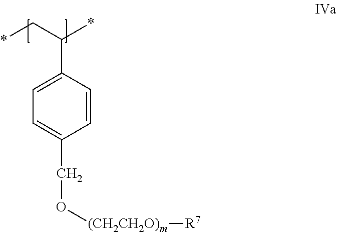
wherein m is 1-20 and R⁷ is a C8-C30 hydrocarbyl, aralkyl or alkaryl moiety.

10. The composition of claim 9 wherein m is 9 and R⁷ is C₁₂H₂₅.

11. The composition of claim 6 wherein one or more repeat units having the structure of formula IV have the structure IVb, 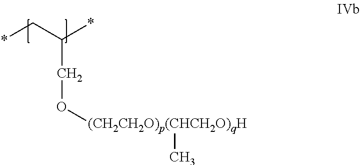
wherein p an q are independently 1-20.

12. The composition of claim 6 wherein the one or more repeat units I is 1 to 1×10⁶ repeat units I, and/or the one or more repeat units II is 1 to 1×10⁶ repeat units II, and/or the one or more repeat units III is 1 to 1×10⁶ repeat units III, and/or the one or more repeat units IV is 1 to 1×10⁶ repeat units IV, and/or the one or more repeat units V is 1 to 1×10⁶ repeat units V.

13. The composition of claim 6 wherein the copolymer comprises a ratio of the one or more repeat units having structure I to the one or more repeat units having structure II that is between 100:1 and 1:100.

14. The composition of claim 6 wherein the copolymer excludes repeat units having structure III and further excludes repeat units having structure IV.

15. The composition of claim 6 wherein the copolymer comprises a ratio of the one or more repeat units having structure I to the one or more repeat units having structure III that is between 100:1 and 1:100.

16. The composition of claim 15 wherein the copolymer excludes repeat units having structure II and repeat units having structure IV.

17. The composition of claim 6, wherein the copolymer comprises a ratio of the one or more repeat units having structure I to the one or more repeat units having structure IV that is between 100:1 and 1:100.

18. The composition of claim 17 wherein the copolymer excludes repeat units having structure II and repeat units having structure III.

19. The composition of claim 5 wherein at least 50% of the copolymer repeat units have structure I.

20. The composition of claim 6 wherein the copolymer comprises a mole ratio of the one or more repeat units having structure II to the one or more repeat units having structure IV that is between 1:3 and 1:1×10⁶.

21. The composition of claim 6 wherein the mineral ore is a bauxite ore or a spodumene ore.

22. A treatment slurry comprising a composition according to claim 6 and about 20 wt % to about 95 wt % water.
